(19) United States
(12) Patent Application Publication
(10) Pub. No.: US 2020/0056999 A1
(43) Pub. Date: Feb. 20, 2020

(54) COLORIMETRIC SENSORS AND METHODS OF USING COLORIMETRIC SENSORS

(71) Applicant: THE REGENTS OF THE UNIVERSITY OF CALIFORNIA, Oakland, CA (US)

(72) Inventors: Javier Read de Alaniz, Santa Barbara, CA (US); Craig Hawker, Santa Barbara, CA (US); James Hemmer, Goleta, CA (US); Yvonne Diaz, Santa Barbara, CA (US); Abigail S. Knight, Santa Barbara, CA (US); Zachariah A. Page, Goleta, CA (US); Tal Margalith, Santa Barbara, CA (US)

(21) Appl. No.: 16/343,907

(22) PCT Filed: Oct. 19, 2017
(86) PCT No.: PCT/US2017/057400

§ 371 Date: Apr. 22, 2019

Related U.S. Application Data
(60) Provisional application No. 62/410,650, filed on Oct. 20, 2016.

(51) Int. Cl. G01N 21/78; G01N 31/22

(52) U.S. Cl. CPC G01N 21/783; G01N 31/223

(57) ABSTRACT

Embodiments of the present disclosure describe a colorimetric sensor comprising a substrate including an activated furan and configured to undergo a color change upon detecting an amine. Embodiments of the present disclosure describe a method of using a colorimetric sensor comprising applying an activated furan to a substrate, providing the substrate to a medium, and detecting an amine in the medium via change in color of the substrate. Embodiments of the present disclosure further describe a method of detecting an amine comprising contacting furfural with a cyclic acceptor group to form an activated furan for detecting amines, and contacting the activated furan with an amine to produce a colored donor-acceptor Stenhouse adduct.

### BACKGROUND

Colorimetric sensors include a family of compounds serving as indicators that undergo a conversion between two different colored states upon being exposed to a stimulus. Through the development of various indicator compounds, a number of techniques have emerged for detecting various stimuli. For example, the techniques that have emerged include high-performance liquid chromatography, gas chromatography, mass spectrometry, electrochemical analysis, immunochips, and enzyme-linked immunosorbent assays. Although some of these techniques may observe high selectivity and/or adequate sensitivity, the techniques are generally impractical for regular use because they are expensive (e.g., high cost) and rely upon sophisticated instrumentation and highly skilled workers. A number of systems have also been developed. However, known systems often result in a loss of sensitivity and selectivity when compared to more intricate methods such as chromatography, electrochemistry, fluorescence, and chemiluminescence. For example, dyes developed for visual detection of amines frequently suffer from low to no selectivity between amines and competing nucleophiles, such as thiols. In addition, alternative colorimetric sensors continue to require difficult synthetic routes.

It would therefore be desirable to provide a colorimetric sensor and a method of using a colorimetric sensor that may be prepared at low cost, interpreted by a human eye or even digital cameras, and applied in various fields of use. It would also be desirable to provide an adaptable and highly accessible colorimetric sensor that maintained the sensitivity and selectivity of more complex systems.

### SUMMARY

In general, embodiments of the present disclosure describe a colorimetric sensor and methods of using a colorimetric sensor.

Accordingly, embodiments of the present disclosure describe a colorimetric sensor comprising a substrate including an activated furan and configured to undergo a color change upon detecting an amine.

Embodiments of the present disclosure further describe a method of using a colorimetric sensor comprising applying an activated furan to a substrate, providing the substrate to a medium, and detecting an amine in the medium via change in color of the substrate.

Another embodiment of the present disclosure is a method of detecting an amine comprising contacting furfural with a cyclic acceptor group to form an activated furan for detecting amines, and contacting the activated furan with an amine to produce a colored donor-acceptor Stenhouse adduct.

The details of one or more examples are set forth in the description below. Other features, objects, and advantages will be apparent from the description and from the claims.

### BRIEF DESCRIPTION OF DRAWINGS

FIG. 1 is a schematic diagram of a reaction to form an activated furan and, upon detecting an amine, a donor acceptor Stenhouse adduct, according to one or more embodiments of the present disclosure.

FIG. 2 is a flowchart of a method of using a colorimetric sensor, according to one or more embodiments of the present disclosure.

FIG. 3 is a schematic diagram showing a selectivity of the activated furans, according to one or more embodiments of the present disclosure.

FIG. 4 is a schematic diagram of a reaction to form an activated furan with Meldrum's acid as an acceptor group, according to one or more embodiments of the present disclosure.

FIG. 5 is a graphical view of a kinetics plot of a reaction between a Meldrum's acid-based activated furan and 0.6 ppm diethylamine, according to one or more embodiments of the present disclosure.

FIG. 6 is a graphical view of a kinetics plot of a reaction between a Meldrum's acid-based activated furan and diethylamine (squares), butylamine (circles), and ammonia (triangles) after about 5 minutes, according to one or more embodiments of the present disclosure.

FIGS. 7a-7b are schematic diagrams showing an interaction between a Meldrum's acid-based activated furan and immobilized peptides (7a) and immobilized peptoids (7b), according to one or more embodiments of the present disclosure.

FIG. 8 is a schematic diagram of a Meldrum's acid-based activated furan TLC stain for tryptamine derivatives, according to one or more embodiments of the present disclosure.

FIG. 9 is a graphical view of visual responses of Meldrum's acid-based activated furan-coated filter paper to vapors of diethylamine, according to one or more embodiments of the present disclosure.

FIG. 10 is a graphical view of responses of Meldrum's acid-based activated furan-sensors over time to a release of amines from decaying cod (top trace) and tilapia (bottom trace), according to one or more embodiments of the present disclosure.

### DETAILED DESCRIPTION

The invention of the present disclosure relates to colorimetric sensors and methods of using colorimetric sensors. In particular, the invention of the present disclosure relates to colorimetric sensors for detecting amines. For example, amines may include, but are not limited to, one or more of ammonia, primary amines, secondary amines, and tertiary amines. In contrast to pH-based sensors, the colorimetric sensors of the present disclosure detect amines via a direct molecular reaction between the chemical sensor (e.g., activated furans) and the analyte (e.g., amines). More specifically, the colorimetric sensors include activated furans that react with amines to form a highly colored and thermodynamically stable form of a donor acceptor Stenhouse adduct (DASA). The reaction is driven by, among other things, the high selectivity and high sensitivity of activated furans towards amines. The color change via the formation of the highly colored DASA products indicates an amine has been detected.

### Definitions

The terms recited below have been defined as described below. All other terms and phrases in this disclosure shall be construed according to their ordinary meaning as understood by one of skill in the art.

As used herein, “applying” refers to coating, dip-coating, etching, doping, epitaxy, thermal oxidation, sputtering, casting, depositing, spin-coating, evaporating, treating, and any other similar variation known to a person skilled in the art.

As used herein, “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo. Accordingly, treating, tumbling, vibrating, shaking, mixing, and applying are forms of contacting to bring two or more components together.

As used herein, “providing” refers to introducing, presenting, placing, laying, dropping, pipetting, and any other similar variations thereof known to a person skilled in the art.

As used herein, “detecting” refers to detecting, noticing, observing, confirming, identifying, monitoring, photographing, quantifying, and any other similar variations thereof known to a person skilled in the art.

Embodiments of the present disclosure describe a colorimetric sensor characterized by Formula (I):

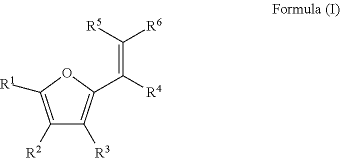

where each of R¹, R², and R³ is independently one or more of -alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, CF₃, —S(alkyl), —S(aryl), —S(heteroaryl), azide, alkyne, and nitrile, wherein each alkyl and aryl group may independently be optionally substituted with one or more groups of C₁-C₆ alkyl, —F, —Cl, —Br, —I, OMe, SMe, and —N,N (C₁-C₂₀ alkyl);

where R⁴ is independently one or more of -hydrogen, alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, —S(alkyl), —S(aryl), —S(heteroaryl), azide, alkyne, and nitrile, wherein each alkyl and aryl group may independently be optionally substituted with one or more groups of C₁-C₆ alkyl, —F, —Cl, —Br, —I, OMe, SMe, and —N,N (C₁-C₂₀ alkyl);

where each of R⁵ and R⁶ is independently a cyclic activating group. Representative examples of the cyclic activating group is provided below:

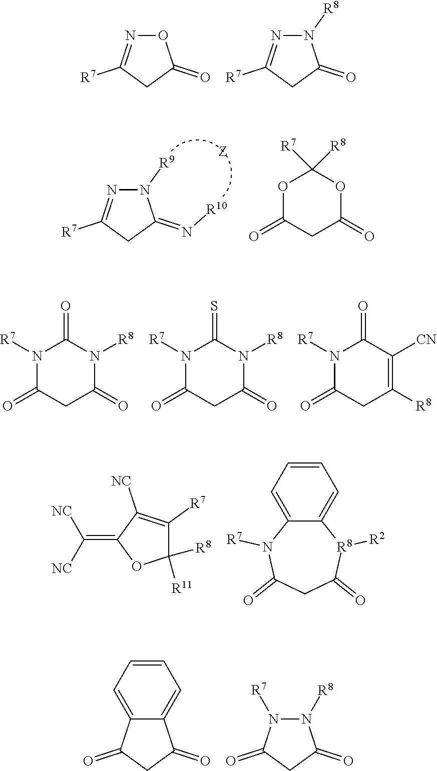

where each of R⁷, R⁸, R⁹, R¹⁰, and R¹¹ is independently one or more of -alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, —S(alkyl), —S(aryl), —S(heteroaryl), azide, alkyne, and nitrile, wherein each alkyl or aryl group may independently be optionally substituted with one or more groups of C₁-C₆ alkyl, —F, —Cl, —Br, —I, OMe, SMe, and —N,N (C₁-C₂₀ alkyl).

where Z is independently one or more of O, N-alkyl, N-aryl, N-heteroaryl, S, and aryl.

Embodiments of the present disclosure describe a colorimetric sensor that changes color in response to detecting an amine or amines. In particular, the colorimetric sensor comprises a substrate including an activated furan. The substrate is configured to undergo a color change upon detecting an amine. As discussed in more detail below, the colorimetric sensor is based on a reaction in which the activated furan reacts with the amine to induce a color change via a formation of a highly colored donor acceptor Stenhouse adduct. The color change functions as a reliable indicator of the presence and/or detection of an amine or amines due to the selectivity and sensitivity of the activated furan towards amines.

The substrate may be a solid or a liquid solution (e.g., dispersed in a liquid solution). In some embodiments, the substrate including the activated furan is a solid. For example, solid substrates may include a coating of the activated furan, either in liquid or solid form, on a solid substrate. In other embodiments, the solid substrate may include one or more of a nylon membrane filter, filter paper, plastic wrap, and any other type of material capable of functioning as a substrate. Substrates may also include, for example, test strips. In other embodiments, the substrate including the activated furan is a liquid solution. For example, the substrate may include a liquid solution of activated furan in a vial.

The activated furan may be based on a furan compound and an acceptor group (e.g., an electron acceptor group). In particular, the activated furan may be obtained via the “on-water” condensation of the furan compound with the acceptor group. In many embodiments, the furan compound includes furfural and the acceptor group includes Meldrum's acid. A benefit of including furfural is that it is an inexpensive derivative of non-edible biomass that is renewable and readily available as an agricultural and/or plant byproduct of corn, oat, wheatbran, etc. A benefit of using Meldrum's acid is its low absorptivity in the visible spectrum and high reactivity with amines. In other embodiments, the activated furan may include furan and/or the acceptor group may include any cyclic acceptor group, including, for example, a cyclic 1,3-dicarbonyl compound. For example, cyclic 1,3-dicarbonyl compounds may include one or more of Meldrum's acid, 1,3-dimethyl barbituric acid, 1,3-indanedione, 3-substituted-1-aryl-pyrazolone, and 3-substituted-5-isoxazole. In other embodiments, the acceptor group includes one or more of 1,2-substituted pyrazolidine-3-5-dione and 1-5-disubstituted-1,5-dihydro-2H-benzodiazepine-2,4-dione.

The substrate undergoes a color change upon detecting an amine or amines. In many embodiments, the color change is a result of a reaction between the activated furan and the amine. The reaction may form a highly colored and thermodynamically stable form of a donor acceptor Stenhouse adduct (DASA). In many embodiments, the color changes from about colorless to about colored. In other embodiments, the color of the substrate may undergo a change from a first color to a second color, wherein the first color and the second color may include any color and/or wherein the first color and the second color are different. In many embodiments, the color change and/or formation of the DASA is a reliable indicator of the sensor having detected an amine due to the selectivity and/or sensitivity of the activated furan towards amines.

The colorimetric sensor may detect amines by reacting with amines to induce a color change. As described above, the selectivity of the colorimetric sensor may be towards amines. The sensitivity of the colorimetric sensor may include concentrations greater than, less than, and/or equal to parts per million. In some embodiments, the colorimetric sensor may detect concentrations equal to or less than parts per million (sub-ppm). The colorimetric sensor may detect one or more of ammonia, a primary amine, a secondary amine, and a tertiary amine. In some embodiments, the colorimetric sensor may detect amines by differentiating between one or more of ammonia, a primary amine, a secondary amine, and a tertiary amine. In some embodiments, the colorimetric sensor may differentiate between amines (e.g., ammonia, primary, secondary, and tertiary amines) via reactivity (e.g., reaction time manifested via a color change). In some embodiments, the colorimetric may detect an amine in any phase, including, but not limited to, one or more of a liquid phase, a gaseous phase, and a vapor phase. In some embodiments, the colorimetric sensor may detect an amine in one or more of an immobilized form and a polymeric form.

The colorimetric sensor of the present disclosure may exhibit one or more of high selectivity and high sensitivity. In some embodiments, the colorimetric sensor exhibits high selectivity towards amines, including one or more of ammonia, primary, secondary, and tertiary amines. The colorimetric sensor also may differentiate between one or more of ammonia, primary, secondary, and tertiary amines. The colorimetric sensor may exhibit high selectivity even in the presence of other competing nucleophiles, including one or more of thiols and alcohols, and in some embodiments, tertiary amines. In some embodiments, the colorimetric sensor detects amines present at concentrations equal to or less than parts per million (sub-ppm).

The activated furan may be tuned according to the requirements of a particular sensing application. In some embodiments, the activated furan may be tuned via the selection of the acceptor group. For example, the acceptor group may be selected to tune (e.g., adjust and/or modify) one or more of a sensitivity of the activated furan, a selectivity of the activated furan, and an intensity of a color change. In some embodiments, the sensitivity of the activated furan may be tuned to adjust a minimum concentration at which an amine or amines may be detected. In some embodiments, the selectivity of the activated furan may be tuned to improve a detection of one or more of ammonia, primary amines, secondary amines, and tertiary amines. In some embodiments, the intensity of the color change may be tuned to increase and/or decrease a hue of the substrate upon detecting an amine.

In addition, a desired absorptivity and/or reactivity of the activated furan, among other things, may be considered in selecting an acceptor group. In many embodiments, an acceptor group is selected such that the activated furan initially appears approximately colorless and exhibits high reactivity with amines. In some embodiments, the activated furan is colorless or approximately colorless (e.g., pale yellowish). Such activated furans may exhibit low molecular absorptivity in the visible spectrum. While the above discussion refers to activated furans with low molecular absorptivity in the visible spectrum and high reactivity with amines, in other embodiments, an acceptor group may be selected to form an activated furan that may not exhibit low molecular absorptivity (e.g., moderate to high molecular absorptivity) and that may not exhibit high reactivity (e.g., low to moderate reactivity).

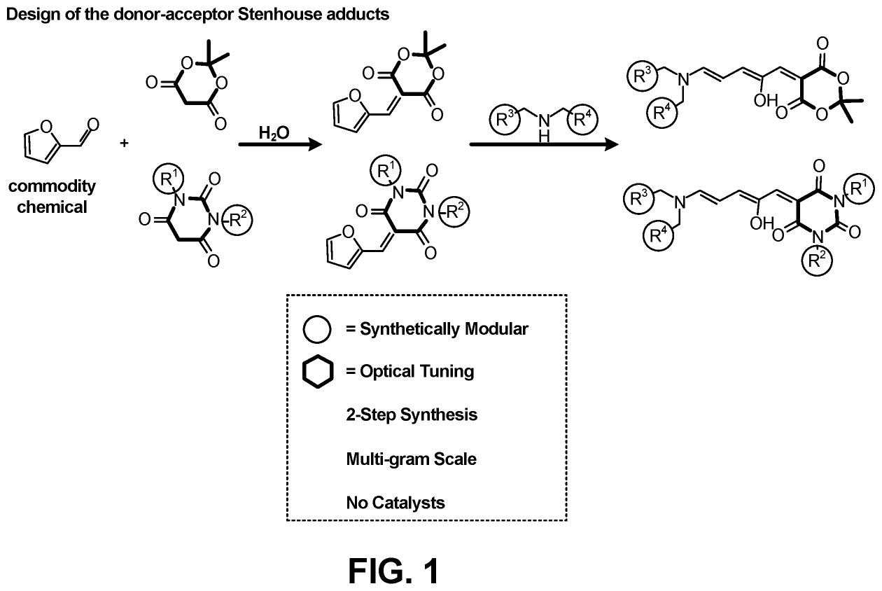

FIG. 1 is a schematic diagram of a reaction to form an activated furan and, upon detecting an amine, a donor acceptor Stenhouse adduct, according to one or more embodiments of the present disclosure. In particular, FIG. 1 illustrates a reaction scheme for forming an activated furan, as well as the reaction scheme upon detecting an amine. For example, as shown in FIG. 1, furfural reacts with Meldrum's acid (upper scheme) and 1,3-dimethylbarbituric acid (lower scheme) to form their respective activated furans. Upon detecting an amine, the activated furan forms a donor acceptor Stenhouse adduct, as shown in FIG. 1.

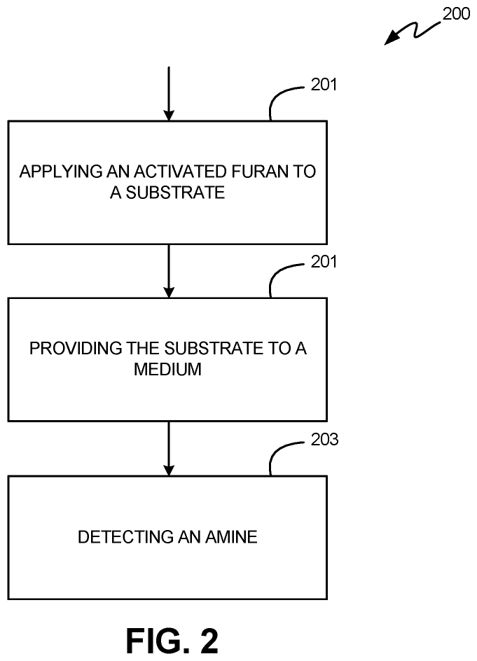

FIG. 2 is a flowchart of a method of using a colorimetric sensor, according to an embodiment of the present disclosure.

At step 201, an activated furan is applied to a substrate. The substrate with the activated furan applied thereto may exist as a liquid or as a solid. In some embodiments, the substrate may exist as a solid. For example, the activated furan may be applied by dip-coating the substrate in a solution of the activated furan. The substrate may include one or more of a nylon membrane filter, filter paper, plastic wrap, and other suitable substrates known to a person skilled in the art. In other embodiments, the substrate may exist as a liquid. For example, the substrate may include a liquid solution of the activated furan.

At step 202, the substrate is provided to a medium. In general, the medium may include any areas and/or objects where amines may or may not be present. In some embodiments, providing the substrate to a medium may include placing a solid substrate on or near an area where amines may or may not be present to detect volatized amines. In other embodiments, providing the substrate to a medium may include providing a liquid substrate drop-wise to an area where amines may or may not be present to detect immobilized amines (e.g., immobilized peptoids and/or peptidomimetics, as well as immobilized peptides and/or peptidomimetics).

At step 203, an amine is detected. In some embodiments, an amine may be detected via a color change. A color change may serve as a reliable indicator of a presence and detection of amines due to the selectivity and/or sensitivity of activated furans towards amines. In some embodiments, an amine may be detected via a color change of the substrate. In other embodiments, an amine may be detected via a color change in the medium. The color change may be visible via an unassisted human eye, a portable spectrometer, and/or a digital camera (e.g., a digital camera in a smartphone).

The colorimetric sensor may be used in a variety of sensing applications. For example, the colorimetric sensors of the present disclosure may be utilized in a variety of laboratory and industrial applications, such as food spoilage monitoring, drug detection, and solid phase synthesis. In some embodiments, the colorimetric sensor may be used to detect amines volatized via a degradation/spoiling of food (e.g., any type of meat, seafood, protein, etc.) and/or volatized as a result of biological activity. In some embodiments, the colorimetric sensor may be used to detect amines in explosives including associated residues, and/or water (e.g., water contaminated by pharmaceutical byproducts). In some embodiments, the colorimetric sensor may detect amines to signal a wound becoming infected. In some embodiments, the colorimetric sensor may detect amines generated via a peptoid coupling reaction and/or via a peptidomimetic coupling reaction (e.g., to detect whether a peptoid/peptidomimetic synthesis reaction has occurred).

In one embodiment, the colorimetric sensor may be used for purposes of assessing a freshness of food, such as fresh, spoiled, or spoiling food. In some embodiments, a test strip and/or label (e.g., indicator) coated with activated furan may be used with elements on the label that change color as amines are produced by bacterial activity. For example, the indicator may be provided on or near food (e.g., food proteins such as meat and seafood) or integrated into packaging, storage areas, and/or any other area where food is or may be present.

To assess a freshness of food, the colorimetric sensor may be applied at any time. In some embodiments, the colorimetric strip may be applied at a time when freshness should be assessed to determine freshness based on a resulting color. In other embodiments, the colorimetric sensor may be applied while food is being stored to determine freshness by monitoring a color change over time. In some embodiments, the color change may be compared (e.g., matched) to a reference color on a label or indicator. In some embodiments, the color change may also be leveraged to highlight text that a user may quickly assess to determine whether food is spoiled. In some embodiments, the color change may be used to determine how many days of usability (e.g., freshness) remain, which may be dependent on factors such as the duration of the storage and conditions thereof (e.g., temperature, humidity, etc.). In some embodiments, a consumer may apply the test strip in a proximity of or in contact with food to determine a freshness at a point in time. In some embodiments, one may add an extracted and/or separated amine to a solid substrate and/or liquid substrate to yield a color change.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

### Colorimetric Sensors Based on Activated Furans

A portable and inexpensive colorimetric sensor capable of detecting sub-ppm levels of amine in the presence of thiols and alcohols was prepared from low-cost, commercially available starting materials. The reaction between cyclic 1,3-dicarbonyl activated furans and these low levels of amines, in solution or when incorporated onto solid supports, produces a pink color under ambient conditions that is distinguishable by the naked eye or by using the digital camera of a smartphone. UV-Vis spectroscopy was used to analyze the kinetics of these reactions in solution and to quantify levels of detectable amine. Additionally, an activated furan solution was used as a colorimetric assay for solid-phase synthesis of peptides, peptoids, and/or peptidomimetics. Finally, activated furan was adsorbed onto nylon filters and used to monitor the real-time release of amines from decaying fish samples.

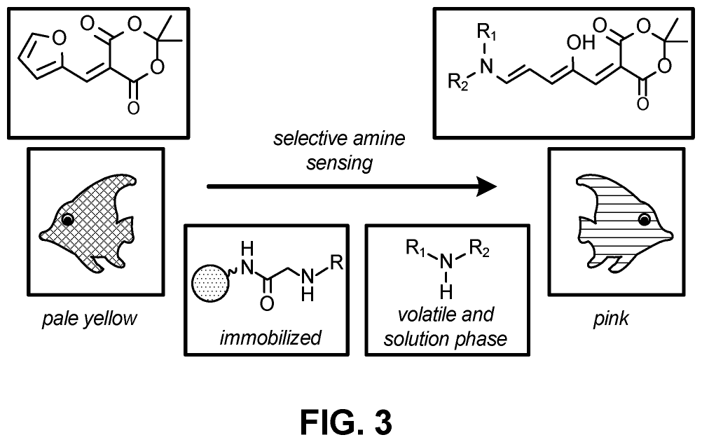

FIG. 3 is a schematic diagram showing a selectivity of the activated furans, according to one or more embodiments of the present disclosure.

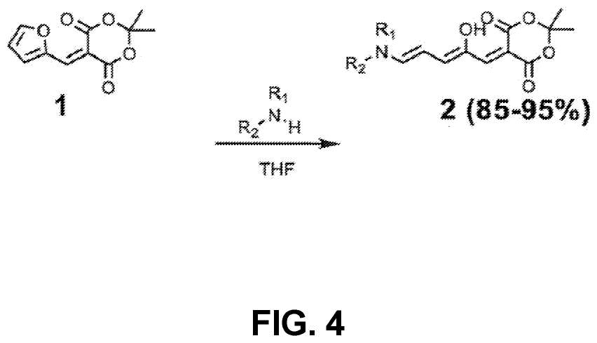

FIG. 4 is a schematic diagram of a reaction to form an activated furan with Meldrum's acid as an acceptor group, according to one or more embodiments of the present disclosure. The activated furan of FIG. 4 may be used as versatile sensors for selective detection of sub-ppm levels of amines. As shown in FIG. 4, a Meldrum's acid-based activated furan (MAF) 1 may react with a primary or secondary amine to form a donor acceptor Stenhouse adduct 2. The disclosure herein demonstrates the effectiveness of these sensors for detection of amines in solution and gas phase as well as for detection of immobilized amines.

Rapid and affordable access to tunable amine sensors was made possible through the facile synthesis of various activated furan-carbon acids. Activated furans, such as the one shown in FIG. 4 as 1, were obtained from the on-water condensation of furfural, an inexpensive derivative of non-edible biomass, with cyclic 1,3-dicarbonyl compounds. The pure product precipitated out of solution in near quantitative yields.

Introducing activated furans to amines produced the highly colored and thermodynamically stable form of a donor acceptor Stenhouse adduct (DASA), such as the one shown in FIG. 4 as 2. Alkyl-based amine DASAs revealed that the characteristic reversible photoswitching of these molecules was not observed in polar solvents or solid-supported matrices. This revealed that the stable, colored form of the DASA 2 would not undergo a color change upon exposure to light when used as a dye for alkyl amine sensors.

Two different acceptor groups were used in the preparation of DASAs: Meldrum's acid and 1,3-dimethyl barbituric acid. This allowed for the ability to tune the sensitivity of activated furans as amine sensors. Comparison of equimolar solutions (about 10 μM in THF) of the two derivatives showed Meldrum's acid activated furans absorbed less in the visible spectrum than the barbituric acid derivatives via UV-vis spectroscopy. This allowed for almost colorless initial solutions when utilizing the Meldrum's acid derivative, a characteristic highly favorable for sensing applications. Solutions of the two activated furans (about 20 mM in THF) were then each reacted with about 10 ppm diethylamine for about 5 min. An intense pink color (about 1 AU via UV-vis) in the Meldrum's acid solution and a pale pink color (about 0.3 AU via UV-vis} in the barbituric acid solution was observed. This revealed a visibly quicker reaction with the Meldrum's acid derivative. Meldrum's acid activated furan was investigated to determine the properties of this sensor due to its low absorptivity in the visible spectrum and higher reactivity. Alternative acceptors including, including but not limited to: barbituric acid, 1,3-indanedione, 3-substituted-1-aryl-pyrazolone, 3-substituted-5-isoxazole may easily be substituted in order to tune the sensitivity of the activated furan with amines.

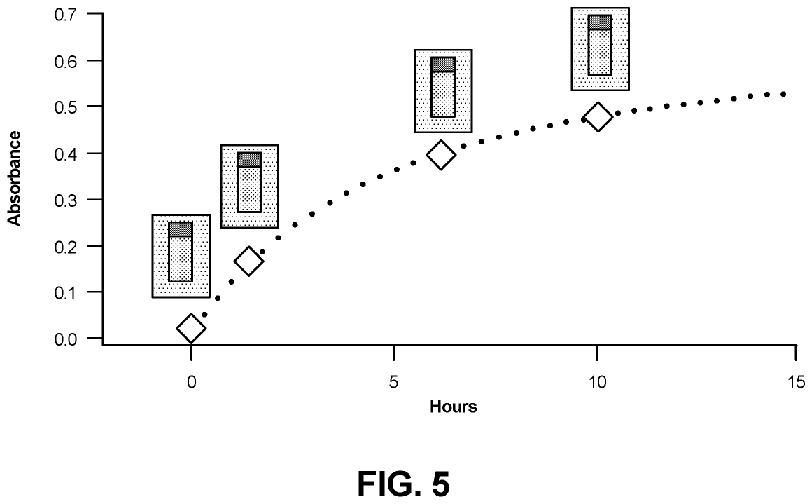

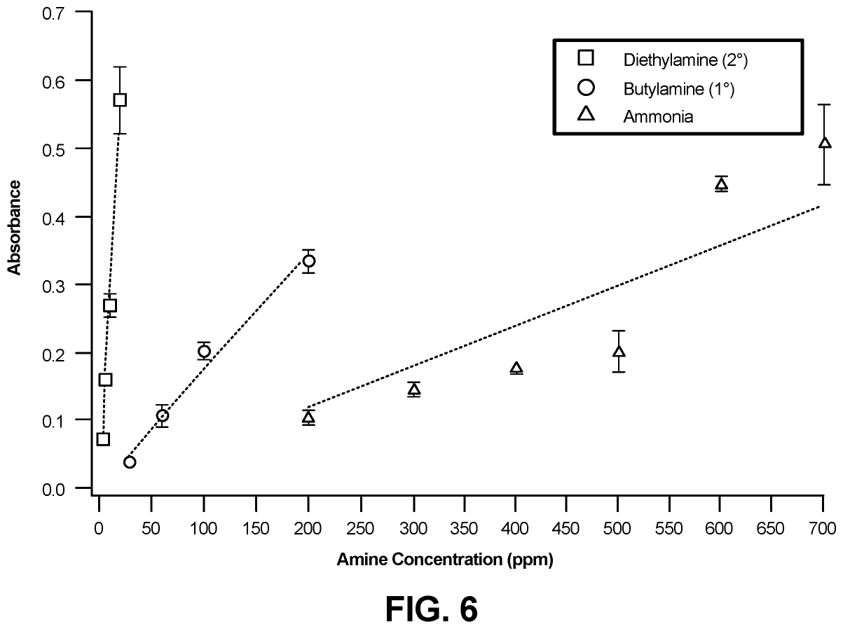

Solutions of Meldrum's acid activated furan, (about 20 mM in THF and DCM) were found to be stable under ambient conditions for (about 6 months to date) with no detectable degradation via ¹H-NMR. FIG. 5 is a graphical view of a kinetics plot of a reaction between a Meldrum's acid-based activated furan and 0.6 ppm diethylamine, according to one or more embodiments of the present disclosure. When about 0.6 ppm diethylamine was introduced to the MAF in THF (about 20 mM), a dramatic change in color from a faint yellow, almost colorless solution to a bright pink solution was observed by the naked eye (FIG. 5). The transformation was also tracked over time by following the increase in absorption at 539 nm (λ max), corresponding to the formation of DASA 2. Due to the high molar absorptivity of the DASA, the interaction of Meldrum's activated furan with higher concentrations of amines, was analyzed at a shorter reaction time of 5 min (FIG. 6). See FIG. 6, for example, which is a graphical view of a kinetics plot of a reaction between a Meldrum's acid-based activated furan and diethylamine (squares), butylamine (circles), and ammonia (triangles) after about 5 minutes, according to one or more embodiments of the present disclosure.

Comparison of a representative primary (butylamine) and secondary (diethylamine) amine revealed that secondary amines reacted much quicker than primary amines. In this way, the sensor distinguished between the presence of primary and secondary amines (aliphatic and cyclic) in solution. Further exploration into other amines, including dimethylamine, piperidine, ammonia, adaverine, and spermidine, revealed similar responses towards other primary and secondary amines, as well as ammonia.

To evaluate the selectivity of this sensor, several potential competing nucleophiles were also evaluated including thiols, tertiary amines, and alcohols. Responses toward these were found to be negligible, confirming the selectivity of this system.

### Detection of Immobilized Amines

Having determined the high sensitivity of activated furans selectively toward primary and secondary amines, effectiveness of the system's ability to signal completion of solid-phase peptide and peptoid and/or peptidomimetic synthesis was investigated. The high stability of the activated furan solution provided easy alternatives to classic ninhydrin and chloranil tests, which are only stable when used less than one month after solution preparation. Additionally, the two-step, on water synthesis of the activated furans provided ready access to these new colorimetric sensors.

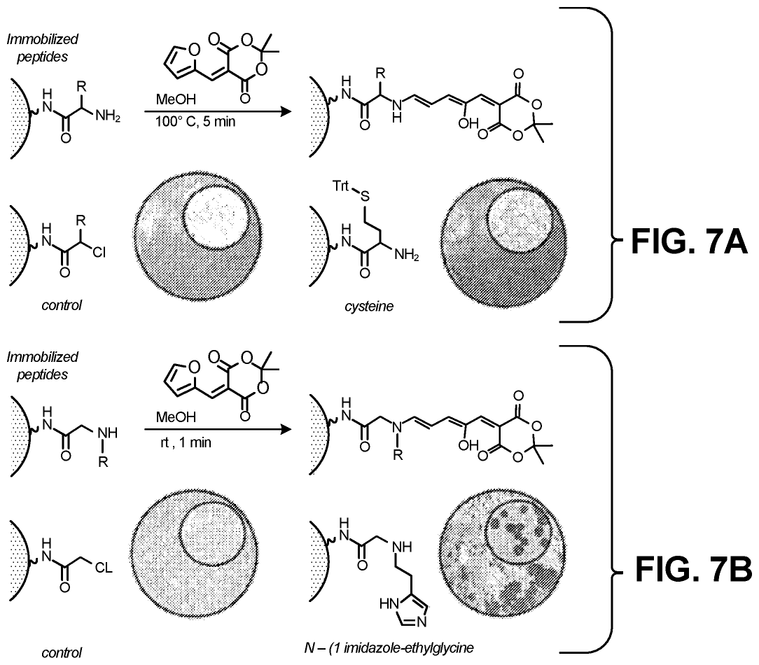

To accomplish this, a solution of Meldrum's activated furan (about 200 mM in THF) was first diluted tenfold into methanol. Importantly, this approach is compatible will activated furan adducts bearing other acceptors such as barbituric acid, 1,3-indanedione, 3-substituted-1-aryl-pyrazolone, 3-substituted-5-isoxazole. Adding only about 2-3 drops of this diluted solution to resin-bound peptides (primary amine) resulted in pink resin beads in about 5 min with heat. FIGS. 7a-7b are schematic diagrams showing an interaction between a Meldrum's acid-based activated furan and immobilized peptides (7a) and immobilized peptoids (7b), according to one or more embodiments of the present disclosure. A bath of boiling water was implemented similar to the procedure for the commonly used Kaiser test (FIG. 7a). Unlike the Kaiser test, the MAF solution was capable of sensing primary and secondary amines, allowing for the detection of all amino acids and most peptidomimetics. The addition of about 2-3 drops of Meldrum's activated furan solution to resin-bound N-substituted glyine sequences, or peptoids, also immediately produced a deep pink color on the resin under ambient conditions (FIG. 7b). This test provided results analogous to the chloranil test, widely used for the detection of secondary amines in solid phase synthesis, without the need of reagents such as acetaldehyde or heat. These results confirmed the activated furan-based system may be an affordable and effective alternative to classic methods in solid-state peptide and peptoid synthesis to determine reaction completion.

### Amine Sensing on Silica

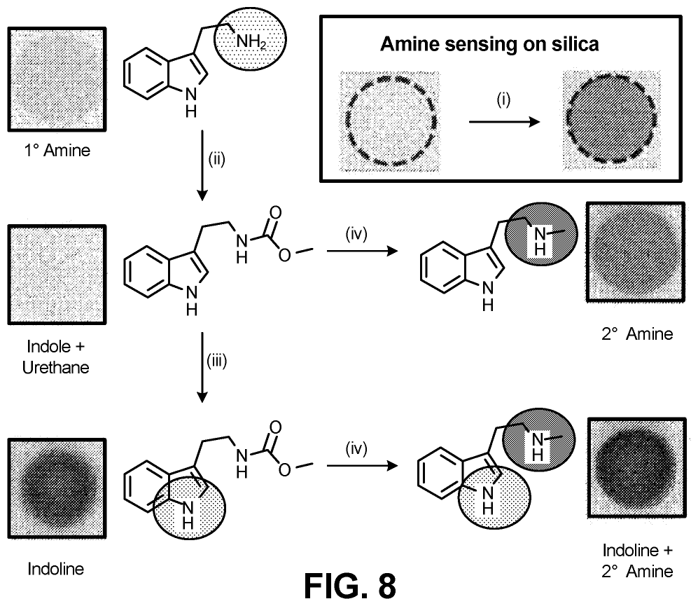

FIG. 8 is a schematic diagram of a Meldrum's acid-based activated furan TLC stain for tryptamine derivatives, according to one or more embodiments of the present disclosure.

### Detection of Volatile Amines

For various applications including food spoilage detection, it was necessary to sense the release of a mines in the vapor phase over time. Given that the detection of volatile amines such as ammonia, dimethylamine, cadaverine, and putrescine were particularly coveted toward the easy detection of meat and fish decomposition, the capabilities of this sensor with these ammonia and dimethylamine were demonstrated.

To evaluate the sensitivity of the colorimetric sensor toward volatile amines, nylon membrane filters were first dip-coated in solutions of Meldrum's activated furan (about 450 mM) in THF. Any number of substrate materials could be used, including but not limited to, filter paper, plastic wrap, etc. These coated filters were sealed within scintillation vials and exposed to various concentrations of ammonia and dimethylamine. After about 5 min, these filters were removed from the vials and an image of the filter paper was captured using the digital camera of a smartphone.

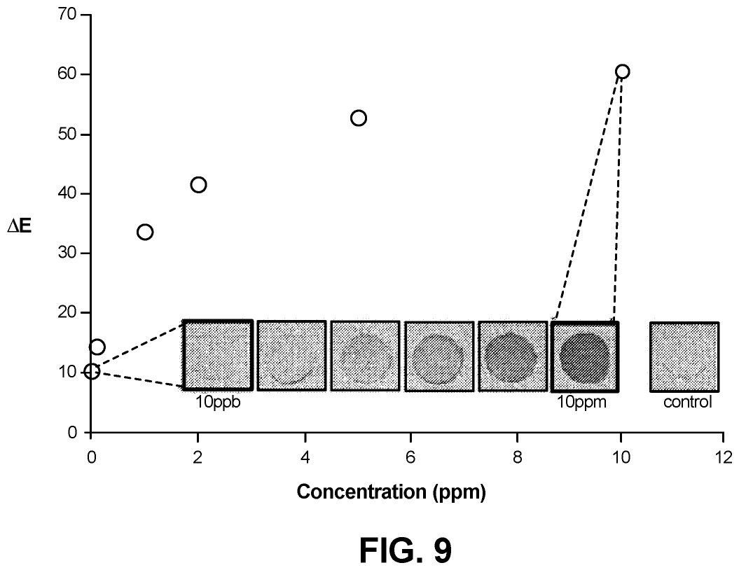

A standard method for quantifying color change was used to analyze each image. Photoshop was first used to extract values of L*a*b* from all images. The vector representing the distance between L*a*b* values of reacted filter paper and that of unreacted filter paper, or ΔE*, was then determined. These results are shown in FIG. 9. In particular, FIG. 9 is a graphical view of visual responses of Meldrum's acid-based activated furan-coated filter paper to vapors of diethylamine, according to one or more embodiments of the present disclosure. As the naked eye can perceive a color change with ΔE* value of about 2-3 or greater, this method demonstrated the ability of this sensor to quickly distinguish between different concentrations of volatile amines down to sub-ppm levels. The use of software analysis is optional.

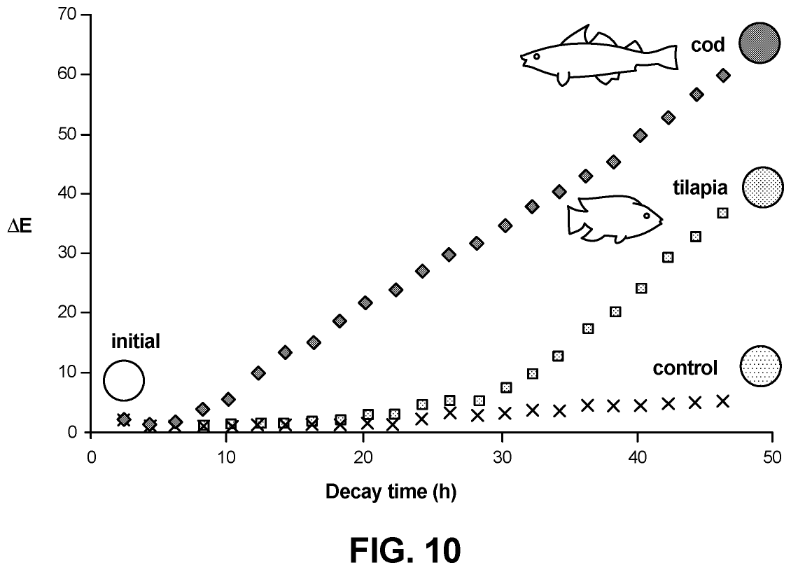

The ease in sensing volatile amines revealed the potential of this sensor to detect food spoilage. As an example, the utility of this sensor for monitoring the release of biological amines from spoiling fish was determined. Cod and tilapia samples were stored at about −22° C. During the spoilage trial, fish samples of approximately 10-15 g were removed from the freezer and allowed to thaw to room temperature for about 2-3 hr. These samples were then sealed into vials containing sensors freshly coated with Meldrum's activated furan at various concentrations. Only the headspace of these vials were tested, and a fresh vial with an empty setup was used as a control. However, the sensitivity to amines in a liquid medium allowed for use of the indicator in contact with the degrading protein. The sensor responses were then monitored over the course of 48 h with Lapse It, a free-time lapse program, and a smartphone (FIG. 10). FIG. 10 is a graphical view of responses of Meldrum's acid-based activated furan-sensors over time to a release of amines from decaying cod (top trace) and tilapia (bottom trace), according to one or more embodiments of the present disclosure. These results demonstrated the ability of this sensor to act as a quick and simple reference in the real-time monitoring of fish spoilage. The sensitivity of this system for a wide range of primary and secondary amines may also be used to detect alternative food spoilage.

The colorimetric sensor was developed as an affordable and easily synthesized sensor for selective detection of amines. As demonstrated herein, the sensor may be applied to monitor reaction progress in the solid phase synthesis of peptides and peptidomimetics and required only one inexpensive and non-toxic reagent as opposed to classic alternatives. Additionally, this activated furan-based sensor was used for the real-time monitoring of amines released from spoiling fish samples. This adaptable colorimetric sensor provides easy access to highly sensitive and selective detection of amines for a wide range of applications.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

1. A colorimetric sensor, comprising:
a substrate including an activated furan of formula (I), wherein a reaction between the activated furan and an amine produces a color change in the colorimetric sensor to indicate the presence of the amines: 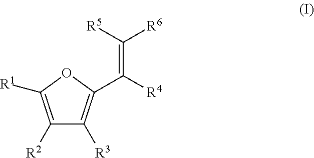
where each of R¹, R², and R³ is independently selected from -alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, CF₃, —S(alkyl), —S(aryl), —S(heteroaryl), azide, alkyne, and nitrile, wherein each alkyl and aryl group is optionally substituted with groups selected from C₁-C₆ alkyl, —F, —Cl, —Br, —I, OMe, SMe, and —N,N (C₁-C₂₀ alkyl);
where R⁴ is independently selected from -hydrogen, alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, —S(alkyl), —S(aryl), —S(heteroaryl), azide, alkyne, and nitrile, wherein each alkyl and aryl group is optionally substituted with groups selected from C₁-C₆ alkyl, —F, —Cl, —Br, —I, OMe, SMe, and —N,N (C₁-C₂₀ alkyl);
where each of R⁵ and R⁶ is independently a cyclic activating group.

2. The colorimetric sensor of claim 1, wherein the substrate is one or more of a liquid solution and a solid.

3-6. (canceled)

7. The colorimetric sensor of claim 1, wherein the cyclic activating group includes one or more of Meldrum's acid, 1,3-dimethyl barbituric acid, 1,3-indanedione, 3-substituted-1-aryl-pyrazolone, 3-substituted-5-isoxazole, 1,2-substituted-pyrazolidine-3-5-dione, and 1-5-disubstituted-1,5-dihydro-2H-benzodiazepine-2,4-dione.

8. The colorimetric sensor of claim 1, wherein the sensor detects the amine in one or more of a liquid phase, gaseous phase, and vapor phase.

9. The colorimetric sensor of claim 1, wherein the sensor detects an immobilized amine in solution.

10. The colorimetric sensor of claim 1, wherein the activated furan reacts with one or more of ammonia, a primary amine, a secondary amine, and a tertiary amine.

11-26. (canceled)

27. The sensor of claim 1, wherein the cyclic activating group is selected from: 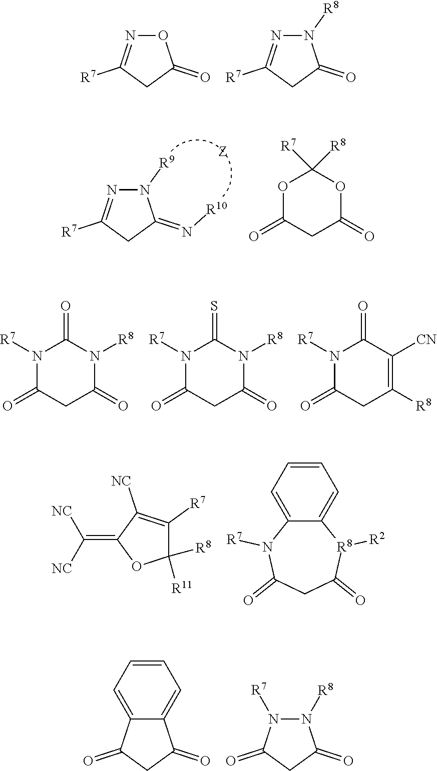
where each of R⁷, R⁸, R⁹, R¹⁰, and R¹¹ is independently one or more of -alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, —S(alkyl), —S(aryl), —S(heteroaryl), azide, alkyne, and nitrile, wherein each alkyl or aryl group may independently be optionally substituted with one or more groups of C₁-C₆ alkyl, —F, —Cl, —Br, —I, OMe, SMe, and —N,N (C₁-C₂₀ alkyl);
where Z is independently one or more of O, N-alkyl, N-aryl, N-heteroaryl, S, and aryl.

28. The sensor of claim 1, wherein the sensor is colorless in the absence of any amines.

29. The sensor of claim 1, wherein the color change in the sensor is produced by the formation of a colored donor acceptor Stenhouse adduct (DASA) formed from the reaction between the activated furan and the amines.

30. The sensor of claim 29, wherein the DASA does not undergo any color change upon exposure to light.

31. The sensor of claim 1, further comprising one of:
a solid substrate, wherein the activated furan is incorporated onto the substrate or adsorbed onto the substrate; and
a liquid substrate, wherein the activated furan is added to the liquid substrate.

32. A method of detecting amines, comprising: exposing the colorimetric sensor of claim 1 to peptoids, peptides, peptidomimetrics, or combinations thereof.

33. The method of claim 32, wherein one or more of the peptoids, peptides, and peptidomimetrics are immobilized.

34. A method of detecting amines, comprising:
exposing the colorimetric sensor to an environment, wherein the colorimetric sensor comprises an activated furan of formula (I) incorporated onto a substrate: 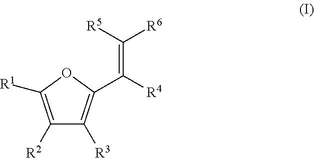
where each of R¹, R², and R³ is independently selected from -alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, CF₃, —S(alkyl), —S(aryl), —S(heteroaryl), azide, alkyne, and nitrile, wherein each alkyl and aryl group is optionally substituted with groups selected from C₁-C₆ alkyl, —F, —Cl, —Br, —I, OMe, SMe, and —N,N (C₁-C₂₀ alkyl);
where R⁴ is independently selected from -hydrogen, alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, —S(alkyl), —S(aryl), —S(heteroaryl), azide, alkyne, and nitrile, wherein each alkyl and aryl group is optionally substituted with groups selected from C₁-C₆ alkyl, —F, —Cl, —Br, —I, OMe, SMe, and —N,N (C₁-C₂₀ alkyl);
where each of R⁵ and R⁶ is independently a cyclic activating group; and
detecting a presence of amines in the environment.

35. The method of claim 34, wherein the amines are detected at concentrations of about 100 ppm or less.

36. The method of claim 34, wherein the amines include volatile amines.

37. The method of claim 34, wherein the cyclic activating group is selected from: 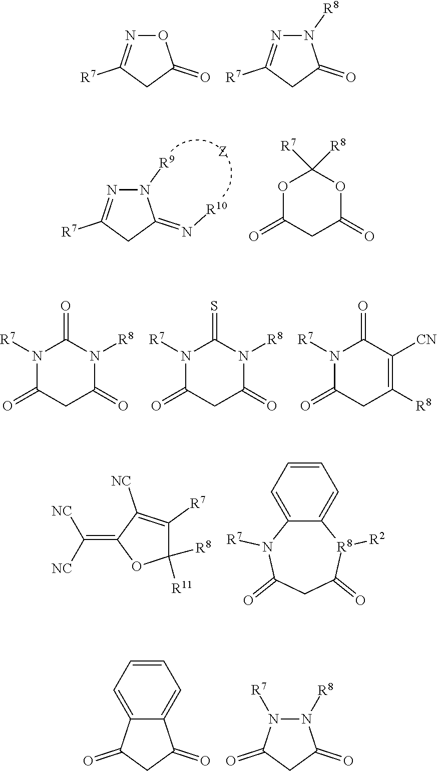
where each of R⁷, R⁸, R⁹, R¹⁰, and R¹¹ is independently one or more of -alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, —S(alkyl), —S(aryl), —S(heteroaryl), azide, alkyne, and nitrile, wherein each alkyl or aryl group may independently be optionally substituted with one or more groups of C₁-C₆ alkyl, —F, —Cl, —Br, —I, OMe, SMe, and —N,N (C₁-C₂₀ alkyl). where Z is independently one or more of O, N-alkyl, N-aryl, N-heteroaryl, S, and aryl.

38. The method of claim 34, wherein the support is selected from nylon membrane filter, filter paper, plastic wrap, and test strips.

39. A method of detecting amines, comprising:
adding a colorimetric sensor to a solution, wherein the colorimetric sensor comprises an activated furan of formula (I): 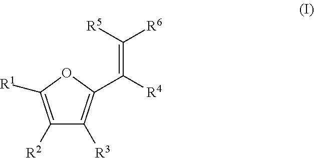
where each of R¹, R², and R³ is independently selected from -alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, CF₃, —S(alkyl), —S(aryl), —S(heteroaryl), azide, alkyne, and nitrile, wherein each alkyl and aryl group is optionally substituted with groups selected from C₁-C₆ alkyl, —F, —Cl, —Br, —I, OMe, SMe, and —N,N (C₁-C₂₀ alkyl);
where R⁴ is independently selected from -hydrogen, alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, —S(alkyl), —S(aryl), —S(heteroaryl), azide, alkyne, and nitrile, wherein each alkyl and aryl group is optionally substituted with groups selected from C₁-C₆ alkyl, —F, —Cl, —Br, —I, OMe, SMe, and —N,N (C₁-C₂₀ alkyl);
where each of R⁵ and R⁶ is independently a cyclic activating group; and
detecting a presence of amines in the solution.

40. The method of claim 39, wherein the cyclic activating group is selected from: 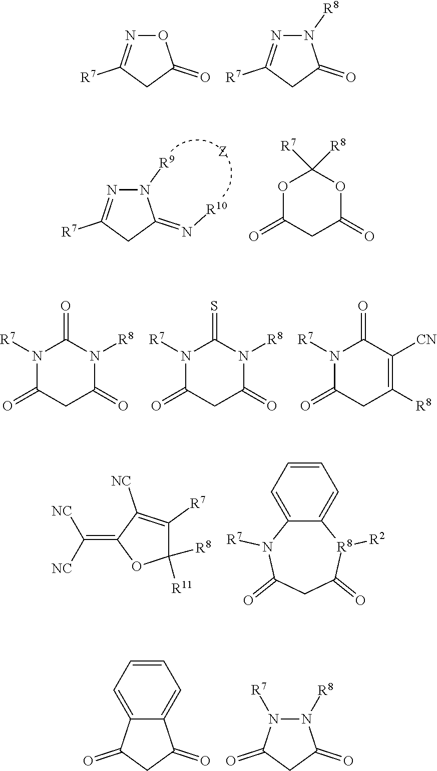
where each of R⁷, R⁸, R⁹, R¹⁰, and R¹¹ is independently one or more of -alkyl, —COOH, —COO(C₁-C₂₀ alkyl), —COO(aryl), aryl, heteroaryl, C₁-C₂₀ alkoxy, C₁-C₂₀ aryloxy, —O(alkyl), —O(aryl), -halogen, —S(alkyl), —S(aryl), —S(heteroaryl), azide, alkyne, and nitrile, wherein each alkyl or aryl group may independently be optionally substituted with one or more groups of C₁-C₆ alkyl, —F, —Cl, —Br, —I, OMe, SMe, and —N,N (C₁-C₂₀ alkyl);
where Z is independently one or more of O, N-alkyl, N-aryl, N-heteroaryl, S, and aryl.
